(19) United States
(12) Patent Application Publication
(10) Pub. No.: US 2025/0029261 A1
(43) Pub. Date: Jan. 23, 2025

(54) METHOD, APPARATUS, DEVICE AND STORAGE MEDIUM FOR MODEL TRAINING

(71) Applicant: Beijing Zitiao Network Technology Co., Ltd., Beijing (CN)

(72) Inventors: Panwang PAN, Beijing (CN); Tao LIU, Beijing (CN); Cheng CHEN, Beijing (CN); Peng DAI, Beijing (CN); Meifeng XIAO, Beijing (CN)

(21) Appl. No.: 18/777,953

(22) Filed: Jul. 19, 2024

(30) Foreign Application Priority Data
Jul. 19, 2023 (CN) 202310890518.6

(51) Int. Cl. G06T 7/20

(52) U.S. Cl. CPC G06T 7/20; G06T 2207/20081

(57) ABSTRACT

Embodiments of the present application provide a model training method and apparatus, and a device and a storage medium, and relate to the technical field of motion capture. The method includes: training a motion capture model according to a preset training set, wherein the motion capture model includes a time series prediction unit; performing, through a quantization node in the time series prediction unit, a quantization operation and an inverse quantization operation in sequence on model data passing through the quantization node; and adjusting a weight parameter of the time series prediction unit according to an update on a gradient of the time series prediction unit until the motion capture model converges, wherein the weight parameter includes a weight scaling parameter and a weight direction.

### CROSS-REFERENCE TO RELATED APPLICATION(S)

This application claims priority to Chinese Application No. 202310890518.6 filed in Jul. 19, 2023, the disclosure of which is incorporated herein by reference in its entity.

### FIELD

Embodiments of the present application relate to the technical field of motion capture, and in particular, to method, apparatus, device and storage medium for model training.

### BACKGROUND

A motion capture technology (referred to as MC technology for short) means that pose-related information of a target object in a natural scene is captured in real time through some sensors, such as an Inertial Measurement Unit (IMU) and a camera, and a virtual image in a virtual scene can be driven based on the captured pose-related information, or behavior analysis in the natural scene is performed.

However, there is a positioning error in the pose-related information of the IMU. Over time, the positioning error continues to be accumulated, resulting in a decrease in the accuracy of motion capture based on the pose-related information.

### SUMMARY

The embodiments of the present application provide a method and apparatus, a device and a storage medium for model training. In an entire training process, a quantization error is continuously introduced, and a weight parameter is decomposed into a weight scaling parameter and a weight direction, so that a model may be trained to converge towards a quantization-friendly direction. Moreover, the model that is trained to converge may eliminate a positioning error caused by an inertial measurement unit, and the prediction accuracy of the model is improved.

In a first aspect, the embodiments of the present application provide a model training method, including:
training a motion capture model according to a preset training set, wherein the motion capture model includes a time series prediction unit; performing, through a quantization node in the time series prediction unit, a quantization operation and an inverse quantization operation in sequence on model data passing through the quantization node; and adjusting a weight parameter of the time series prediction unit according to an update on a gradient of the time series prediction unit until the motion capture model converges, wherein the weight parameter includes a weight scaling parameter and a weight direction.

Alternatively, performing a quantization operation and an inverse quantization operation in sequence on model data passing through the quantization node includes: performing the quantization operation on the model data based on a preset maximum value, a preset minimum value, and a preset scaling factor; and performing the inverse quantization operation on the quantized model data based on the scaling factor.

Alternatively, the update on the gradient of the time series prediction unit satisfies a preset normal form constraint, and the preset normal form constraint includes a weight parameter and a diagonal matrix corresponding to the weight parameter.

Alternatively, the weight parameter includes one or more of a parameter of a hidden layer forget gate, a parameter of a hidden layer input gate, a parameter of a hidden layer output gate, and a parameter of a hidden layer activation gate.

Alternatively, the preset normal form constraint includes:

$$‖ \frac{\partial ξ m}{\partial {ℏ}_{t - 1}} ‖ - ( \frac{{g}_{i}}{4} {‖ {D}_{i}^{- 1} {W}_{hi} ‖}_{2} + \frac{γ 1 {g}_{f}}{4} {‖ {D}_{f}^{- 1} {W}_{hf} ‖}_{2} + {g}_{a} {‖ {D}_{a}^{- 1} {W}_{ha} ‖}_{2} ) ‖ \frac{\partial ξ m}{\partial {c}_{t + 1}} ‖ \leq ( \frac{{g}_{i}}{4} {‖ {D}_{i}^{- 1} {W}_{hi} ‖}_{2} + \frac{γ 1 {g}_{f}}{4} {‖ {D}_{f}^{- 1} {W}_{hf} ‖}_{2} + {g}_{a} {‖ {D}_{a}^{- 1} {W}_{ha} ‖}_{2} + \frac{{g}_{o}}{4} {‖ {D}_{o}^{- 1} {W}_{h o} ‖}_{2} ) ‖ \frac{\partial ξ m}{\partial {ℏ}_{t - 1}} ‖ ;$$

where ∂ represents a partial derivative; ξₘ represents a parameter of a network; D represents a diagonal matrix; W_{hf} and gr respectively represent the parameter of the hidden layer forget gate and a corresponding gradient; Wₕᵢ and gᵢ respectively represent the parameter of the hidden layer input gate and a corresponding gradient; Wₕₒ and gₒ respectively represent the parameter of the hidden layer output gate and a corresponding gradient; and Wₕₐ and gₐ respectively represent the parameter of the hidden layer activation gate and a corresponding gradient.

Alternatively, the model data includes at least one of a weight of input data of the time series prediction unit, a weight of short-term memory data, biase data, and output data of the time series prediction unit.

Alternatively, the method further includes: performing a weight normalization operation on the motion capture model to enable a weight to follow a normal distribution within a preset range.

Alternatively, an activation function of the time series prediction unit includes a Relu activation function and a LeakyRelu activation function.

Alternatively, the weight direction is determined according to a weight of the weight parameter and a modulus of the weight.

Alternatively, the method further includes: revoking the quantization node in the time series prediction unit in a case that the motion capture model converges.

In a second aspect, the embodiments of the present application provide a model training apparatus, including:
a training module, configured to train a motion capture model according to a preset training set, wherein the motion capture model includes a time series prediction unit; the time series prediction unit includes a quantization node; the quantization node is used for performing a quantization operation and an inverse quantization operation in sequence on model data passing through the quantization node; and
an adjustment module, configured to adjust a weight parameter of the time series prediction unit according to an update on a gradient of the time series prediction unit until the motion capture model converges, wherein the weight parameter includes a weight scaling parameter and a weight direction.

In a third aspect, the embodiments of the present application provide an electronic device, including: a processor and a memory. The memory is configured to store a computer program, and the processor is configured to call and run the computer program stored in the memory to perform the method as described in the first aspect or in the various implementations of the first aspect.

In a fourth aspect, the embodiments of the present disclosure provide a computer-readable storage medium, including a computer program. The computer program, when run by the processor, causes the processor to perform the method as described in the first aspect.

In summary, in the embodiments of the present application, when a motion capture model is trained based on a preset training set, a quantization node is inserted into a time series prediction unit of the motion capture model (such as, a Long Short-Term Memory (LSTM) unit). A quantization operation and an inverse quantization operation may be performed in sequence on model data passing through the quantization node to introduce quantization errors into the model data. The introduced quantization errors may simulate a positioning error of an inertial measurement unit, thereby reducing the impact caused by the quantization errors in the training process. With an update on a gradient of the model, model parameters are adjusted to continuously decrease the gradient. Furthermore, due to the introduction of the quantization errors into the model parameters of the present application, a weight parameter of the time series prediction unit is decomposed into a weight scaling parameter and a weight direction. In a method for only adjusting a weight of the weight parameter, the accumulation of the quantization error may make the model not trained towards an expected quantization-friendly direction, but adjusting the weight scaling parameter and the weight direction can control a gradient update direction to ensure that the model is trained to converge towards the quantization-friendly direction with the update of the gradient. The converged motion capture model may not only achieve quantization-friendliness, but also solve the problem of an accuracy decrease caused by the positioning errors, accumulated over time, of the inertial measurement unit.

### BRIEF DESCRIPTION OF THE DRAWINGS

To describe the technical solutions in the embodiments of the present invention more clearly, the following briefly describes the accompanying drawings required for describing the embodiments. Apparently, the accompanying drawings in the following description show merely some embodiments of the present invention, and a person of ordinary skill in the art may still derive other drawings from these accompanying drawings without creative efforts.

FIG. 1 is a schematic diagram of an application scene of a model training method provided by an embodiment of the present application;

FIG. 2 is a flowchart of a model training method provided by an embodiment of the present application;

FIG. 3 is a flowchart of a model training method provided by an embodiment of the present application;

FIG. 4 is a schematic diagram of a model training method provided by an embodiment of the present application;

FIG. 5 to FIG. 7 are distribution diagrams of a weight of a time series prediction unit before and after training provided by an embodiment of the present application;

FIG. 8 is a flowchart of a model training method provided by an embodiment of the present application;

FIG. 9 is a schematic structural diagram of a time series prediction unit provided by an embodiment of present application;

FIG. 10 is a schematic structural diagram of a model training apparatus provided by an embodiment of the present application; and

FIG. 11 is a schematic block diagram of an electronic device provided by an embodiment of the present application.

### DETAILED DESCRIPTION OF EMBODIMENTS

The technical solutions in the embodiments of the present disclosure will be clearly and completely described below with reference to the drawings in the embodiments of the present disclosure, and it is obvious that the described embodiments are only a part of the embodiments of the present disclosure but not all of them. All other embodiments obtained by a person of ordinary skill in the art based on the embodiments of present invention without making creative efforts shall fall within the protection scope of present invention.

It should be noted that the terms “first”, “second”, etc. in the specification and claims of the present invention and the above schematic diagrams are defined to distinguish similar objects, and do not have to be used to describe a specific order or sequence. It should be understood that such used data is interchangeable where appropriate, so that the embodiments of the present invention described here can be implemented in an order other than those illustrated or described here. In addition, the terms “include” and “have”, as well as any variations thereof, are intended to cover non-exclusive inclusion. For example, a process, method, system, product, or server that includes a series of steps or units does not need to be limited to those clearly listed steps or units, but may include other steps or units not clearly listed or inherent to these processes, methods, products, or equipment.

Before introduction of the technical solutions of the present application, the following will introduce relevant knowledge of the present application first.

A long short-term neural network is a basic network structure in contemporary neural networks, and is classified to the class of Recurrent Neural Network (RNN).

Usually, a Long Short-Term Memory (LSTM) is usually used to extract time series information. In terms of images and videos, a single image does not have time series information, but a video composed of consecutive images contains time series information. In combination with “motion capture” described, a frame of pose of a target object (such as a human body) has no time series information, but a plurality of concussive frames of poses of the target object contain time series information. The present application extracts time series information of the target object during motion for final motion capture.

Functions used by the LSTM for data processing are as follows:

$$\begin{matrix}\begin{matrix}{\tilde{l}}_{t} & W 𝒩 ( {W}_{xi} {x}_{t} ) + W 𝒩 ( {W}_{hi} {h}_{t - 1} ) & {b}_{i}\end{matrix} \\ [ {\tilde{f}}_{t} ] = [ W 𝒩 ( {W}_{xf} {x}_{t} ) + W 𝒩 ( {W}_{hf} {h}_{t - 1} ) ] + [ {b}_{f} ] \\ \begin{matrix}{\tilde{a}}_{t} & W 𝒩 ( {W}_{x a} {x}_{t} ) + W 𝒩 ( {W}_{ha} {h}_{t - 1} ) & {b}_{a}\end{matrix} \\ \begin{matrix}{\tilde{o}}_{t} & W 𝒩 ( {W}_{xo} {x}_{t} ) + W 𝒩 ( {W}_{ho} {h}_{t - 1} ) & {b}_{o}\end{matrix}\end{matrix} \qquad ( 1 )$$

$${c}_{t} = σ ( {i}_{t} ) ⊙ tanh ( {a}_{i} ) + σ ( {f}_{t} ) ⊙ {c}_{t - 1} \qquad ( 2 )$$

$${h}_{t} = σ ( {o}_{t} ) ⊙ tanh ( {c}_{t} ) \qquad ( 3 )$$

$${x}_{t} = [ {C}_{t - 1} , {x}_{input} ] \qquad ( 4 )$$

where the four WN(*) and b* all represent a weight matrix of the LSTM structure itself, which means a learnable parameter matrix; Xₜ represents input data at time t (such as a current frame); xᵢₙₚᵤₜ represents a current frame of pose data acquired by a pose sensor; and iₜ, fₜ, aₜ, and oₜ respectively represent intermediate calculation results of the LSTM at time t.

Output information of the LSTM includes two parts, namely hₜ and cₜ, where hₜ represents short-term memory data, and cₜ represents long-term memory data; hₜ₋₁ represents the short-term memory data extracted by the LSTM at time (t−1), namely, a previous frame of short-term memory data; and Cₜ₋₁ represents long-term memory data extracted by the LSTM at time (t−1).

σ is an activation function, such as a sigmoid activation function; tanh is a hyperbolic tangent function; and ⊙ is an element-by-element multiplication operation. For example, this operation is performed in matrix A and matrix B which have the same size, matrix C with the same size is obtained, where an element at a corresponding position in C is equal to a product obtained by multiplying elements at the corresponding positions in A and B.

It should be understood that the technical solution of the present application may be applied to the following scenes, but is not limited to:

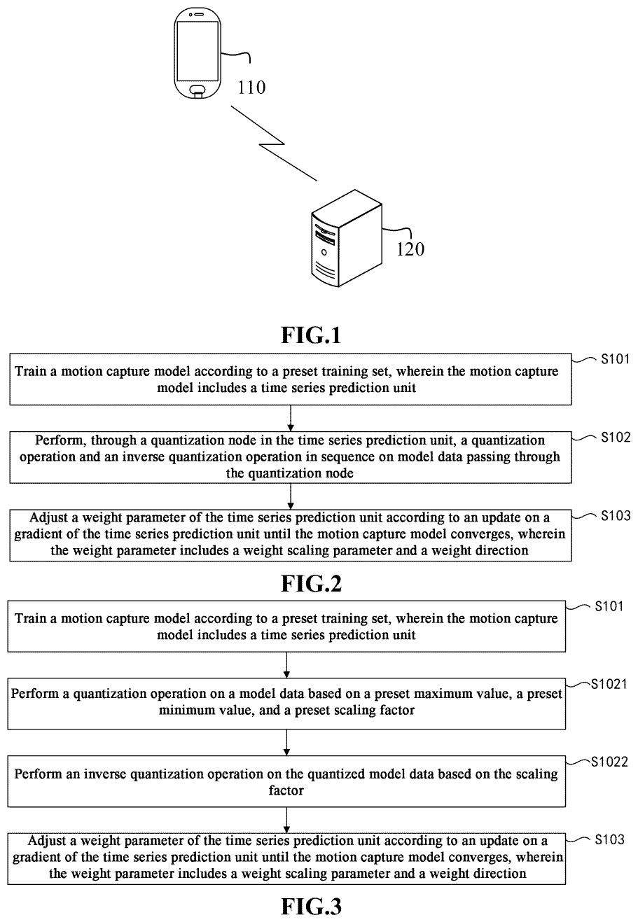

Exemplarily, FIG. 1 is a schematic diagram of an application scene of a model training method provided by an embodiment of the present application. As shown in FIG. 1, the application scene involves a terminal device 110 and a server 120, and the terminal device 110 may communicate with the server 120.

Alternatively, the application scene shown in FIG. 1 may further include: a base station, a core network side device, and the like. In addition, FIG. 1 exemplarily shows one terminal device and one server, which may actually include other quantities of terminal devices and servers. This embodiment of the present application does not limit this.

Alternatively, the server 120 as shown in FIG. 1 may be an independent physical server, or may be a server cluster or a distributed system formed by a plurality of physical servers, or may be a cloud server that provides basic cloud computing services such as cloud services, cloud databases, cloud computing, cloud functions, cloud storage, network services, cloud communication, middleware services, domain name services, security services, Content Delivery Networks (CDN), big data, and artificial intelligence platforms. This embodiment of the present application does not limit this.

Alternatively, the terminal device 110 as shown in FIG. 1 may be installed with an application client. When run on the terminal device 110, the application client may perform data interaction with the server 120. For example, the client here may specifically include: a vehicle-mounted client, a smart home client, a game client, a multimedia client (such as a video client), a social client, and an information client (such as a news client).

Alternatively, in the embodiments of the present application, the terminal device 110 may be a device having rich human-computer interaction modes and an ability to access the Internet and usually carrying various operating systems, and having high processing capability. The terminal device 110 may be, but is not limited to this, a smartphone, a smart TV, a tablet, a vehicle-mounted terminal, and the like.

Alternatively, the server 120 and the terminal device 110 may perform the model training method provided by an embodiment of the present application through interactions, or the terminal 110 may perform the model training method provided by an embodiment of the present application.

In a training stage of a motion capture model, the server 120 or the terminal device 110 uses the model training method provided in an embodiment of the present application to train the motion capture model.

In a pose detection stage of a target object, a user may run the motion capture model through the application client, the browser client, and the like installed in the terminal device 110, obtain pose data of an IMU installed on the target object through a motion model, and input the pose data to the motion capture model to detect a pose of the target object.

For example, a human body used as the target object is taken as an example. Inertial measurement units may be worn to different parts of the human body (such as the left hand, the right hand, the left wrist, the right wrist, the left knee, the right knee, the head, and the waist). Pose information of the human body may be described by turning information of a plurality of sections of bones of the human body. As a rigid body, the turning information of any point on a bone is consistent. Therefore, the pose information of the human body may be represented by pose data acquired by the inertial measurement units at different parts of the human body.

Alternatively, the pose data may include six-degree-of-freedom (6DoF) pose data of the head of the human body: a position and an orientation (represented by R6D), and 6DoF pose data of the hands of the human body: a position and an orientation (represented by R6D).

After the pose data is input to the motion capture model, the motion capture model can output the pose of the target object, such as the 6DoF position information of key points of the whole body of the target object: (x, y, z, R_x, R_y, R_z).

Alternatively, the motion capture model provided by an embodiment of the present application may be further run on the server 120. The terminal device 110 obtains pose data and uploads the pose data to the server 120, and the server 120 then runs the motion capture model to process the pose data, and sends the detected pose of the target object to terminal device 110. The terminal device 110 may achieve motion capture on the target object according to the pose of the target object, thereby driving a virtual image in a virtual scene, performing behavior analysis in a natural scene, or the like.

It should be noted that the training process of the motion capture model and the pose detection process of the target object may be completed in the server 120 or the terminal device 110. Alternatively, a trained model file trained by the server 120 may be transmitted to the terminal device 110.

In the related technology, a whole-body motion capture technology refers to a technology for recording, capturing, and processing human motions, and has a very wide range of applications. This technology is suitable for fields such as sports, gaming, virtual reality, 3D character animation production, visual effects, and film production. Traditional motion capture methods have many limitations, such as: low identification accuracy and low processing efficiency.

When motion capture is performed, the IMU may generally be used to acquire the pose data of the target object. Based on IMU positioning, a positioning solution is based on motion integration, and a positioning error in a previous positioning result will be accumulated to a current positioning result. Meanwhile, due to the zero bias of the IMU itself, the positioning error will be finally accumulated over time.

To solve this technical problem, the present application inserts a quantization node into a time series prediction unit of the motion capture model. A quantization operation and an inverse quantization operation may be performed in sequence on model data passing through the quantization node to introduce quantization errors into the model data. The introduced quantization errors may simulate a positioning error of an inertial measurement unit, thereby reducing the impact caused by the quantization errors in the training process. With an update on a gradient of the model, model parameters are adjusted to continuously decrease the gradient. Furthermore, due to the introduction of the quantization errors into the model parameters of the present application, a weight parameter of the time series prediction unit is decomposed into a weight scaling parameter and a weight direction. In a method for only adjusting a weight of the weight parameter, the accumulation of the quantization error may make the model not trained towards an expected quantization-friendly direction, but adjusting the weight scaling parameter and the weight direction can control a gradient update direction to ensure that the model is trained to converge towards the quantization-friendly direction with the update of the gradient. The converged motion capture model can not only achieve quantization-friendly, but also solve the problem of an accuracy decrease caused by the positioning errors, accumulated over time, of the inertial measurement unit.

The technical solutions of the present application will be described in detail below.

FIG. 2 is a flowchart of a model training method provided by an embodiment of the present application. The method, for example, may be performed by, but not limited to, the terminal device 110 as shown in FIG. 1. As shown in FIG. 2, the method may include the following steps:

S101: A motion capture model is trained according to a preset training set, and the motion capture model includes a time series prediction unit.

Specifically, in the embodiments of the present application, the training set may be generated by pose data acquired by an inertial measurement unit and an actual pose corresponding to the pose data.

In the related technology, a motion capture technology for obtaining pose information in an end-to-end manner based on a deep learning model may typically use a deep learning model (hereinafter referred to as model) containing a time series structure, such as a Temporal Convolutional Network (TCN), a Multilayer Perceptron (MLP), a Transformer, an LSTM, and a Gated Recurrent Unit (GRU).

Both the TCN and the MLP network use a fixed time window to assist in prediction of a whole-body motion capture model. However, when the time window is set to be too small, the neural network may not use long-term historical data. When the time window is set to be too large, it will bring significant overheads on memory and computation, so that this technology cannot be implemented on an embedded device. The Transformer network based on a self-attention mechanism is an alternative solution, and its structure can indeed achieve a significant improvement on the performance of the deep neural network. However, the Transformer network has introduced lots of computational complexity, which cannot meet a need of real-time inference for embedded devices such as a Virtual Reality (VR) head-mounted device and a mobile terminal. Moreover, the Transformer network has many hardware-unfriendly operators, so that it is hardly deployed on heterogeneous hardware.

For the LSTM structure, after the inference of a current frame of the model is completed, only a Hidden-State of the current frame needs to be cached. during inference of a next frame, the Hidden-State is input as input data. This greatly reduces the computation cost of model inference.

The motion capture model of the present application may use the LSTM structure. The motion capture model includes one or more-time series prediction units (i.e. LSTM units). Therefore, since an LSTM unit may reduce the computational complexity of the model, it is conducive to achieving model lightweight and enabling the model to get rid of the computation bottleneck and be deployed to more resource-limited devices. Moreover, the LSTM structure may further improve the detection ability of the model, so that the model has a lightweight structure and high efficiency.

S102: A quantization operation and an inverse quantization operation are performed, through a quantization node in the time series prediction unit, in sequence on model data passing through the quantization node.

Specifically, in a training process of the motion capture model, the time series prediction unit may process input data. In the time series prediction unit, the input data includes a current frame of sample data in the training set and short-term memory data extracted by the time series prediction unit from a previous frame. Both the current frame of sample data and the short-term memory data have corresponding weights.

To simulate a positioning error of the IMU, the time series prediction unit may set a quantization node corresponding to the current frame of sample data and a quantization node corresponding to the short-term memory data. The quantization node corresponding to the current frame of sample data may perform a quantization operation and an inverse quantization operation on the weight of the current frame of sample data, and the quantization node corresponding to the short-term memory data may perform a quantization operation and an inverse quantization operation on the weight of the short-term memory data. Therefore, quantization errors are introduced into both the current frame of sample data and the short-term memory data to simulate a positioning error in the current frame of sample data and a positioning error in the short-term memory data extracted from the previous frame.

Referring to FIG. 3, alternatively, in step S102, a quantization operation and an inverse quantization operation are performed in sequence on model data passing through the quantization node, which includes:

Step S1021: The quantization operation is performed on the model data based on a preset maximum value, a preset minimum value, and a preset scaling factor.

The quantization operation refers to the process of making a floating-point activation value or weight (which is usually represented by a 32-bit floating-point number) approximate to a fixed-point number with low bits (16 bits or 8 bits), thus completing a computation process in a low-bit representation.

For example, the quantization operation is performed on the weight of the short-term memory data, which may be achieved using the following function:

$${x}_{int} = clamp ( ⌊ \frac{x}{s} ⌉ ; 0 , {2}^{b} - 1 ) ,$$

where xᵢₙₜ represents quantized data; x represents model data to be quantized (such as the short-term memory data); s represents a scaling factor; and 0 and 2^{b}-1 represent a minimum value and a maximum value of the quantized model data. In this way, the quantization operation performed on the model data can be completed.

Alternatively, the model data may include at least one of a weight of input data of the time series prediction unit, a weight of short-term memory data, biase data, and output data of the time series prediction unit.

Specifically, in FIG. 4, Quantize represents a quantizer, configured to quantify corresponding model data; De-Quantize represents an inverse quantizer, configured to inversely quantize corresponding model data; Weight represents a weight; and bias represents biasing.

By introducing a quantization error into at least one of the weight (e.g., input's Weight) of the input data of the time series prediction unit, the weight (e.g., hx's Weight) of the short-term memory data, the bias data (e.g., Bias), and the output data (e.g., output short-term memory data hₓ and long-term memory data cₓ) of the time series prediction unit, the quantization error can be introduced into the model. It can be understood that if more types of quantization errors are introduced, it is more conductive to improving the adaptability of the converged model to different quantization errors, so that the model can better eliminate various quantization errors.

Therefore, the corresponding quantization errors can be introduced into the weight of the input data, the weight of the short-term memory data, the bias data, and the output data of the time series prediction unit, so that the adaptability of the model to the quantization errors can be maximized, and the ability of the model to eliminate the quantization errors may be improved, thereby improving the detection accuracy of the model.

Step S1022: The inverse quantization operation is performed on the quantized model data based on the scaling factor.

The inverse quantization operation is in contrary to the and can be implemented using the following function:
For asymmetric quantization, the function is x=s*(xᵢₙₜ−z); and
for symmetric quantization, the function is x=s*xᵢₙₜ.

Wherein s is a scaling factor that is the same as the scaling factor of the quantization operation, and z represents a corresponding integer after quantization of 0 among real numbers.

Generally, the quantization operation may compress the model data to transform the model data from a floating-point number into a fixed-point number, thereby reducing the model storage cost and the computational complexity. The quantized model data may change a lot, leading to distortion in the model data. However, the present application is only intended to introduce the quantization errors. Therefore, it is necessary to perform the inverse quantization operation on the quantized model data. The inversely quantized model data is still a fixed-point number and has a small difference from the data before quantization. The difference therebetween is the introduced quantization error. In this way, by quantization and inverse quantization, the introduction of the quantization errors can be achieved, and the accuracy loss is small when the fixed-point number is used to represent the model data, so that a hardware requirement for the model is lowered.

Step S103: A weight parameter of the time series prediction unit is adjusted according to an update on a gradient of the time series prediction unit until the motion capture model converges, wherein the weight parameter includes a weight scaling parameter and a weight direction.

Specifically, in the training process, with the update on the gradient of the time series prediction unit, the model may continuously adjust the weight parameter of the time series prediction unit, so that the gradient of the model continuously decreases until the model converges.

In the present application, the quantization node is inserted into the time series prediction unit, which introduces the quantization errors. As the model is trained, the errors may be accumulated continuously. If only the weight of the weight parameter is adjusted, the gradient of the model may not decrease, and the model may not be trained to converge towards the quantization-friendly direction. Therefore, in the present application, the weight parameter is decomposed into a scale (i.e. the weight scaling parameter) and a direction (i.e. the weight direction). Adjusting the weight scaling parameter and the weight direction may control a gradient update direction to ensure that the model is trained to converge towards the quantization-friendly direction with the update of the model. The converged motion capture model may not only achieve quantitative-friendliness, but also solve the problem of an accuracy decrease caused by the positioning error, accumulated over time, of the inertial measurement unit.

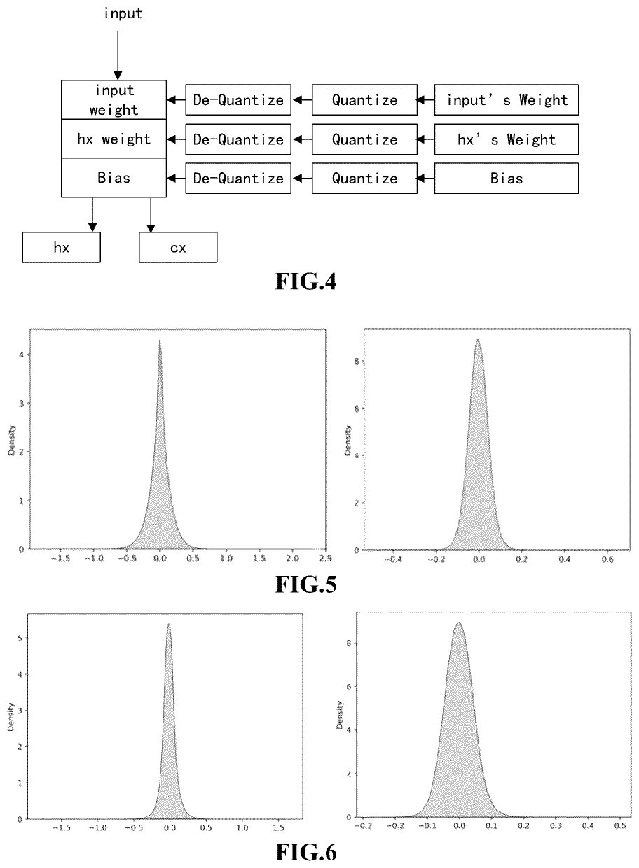

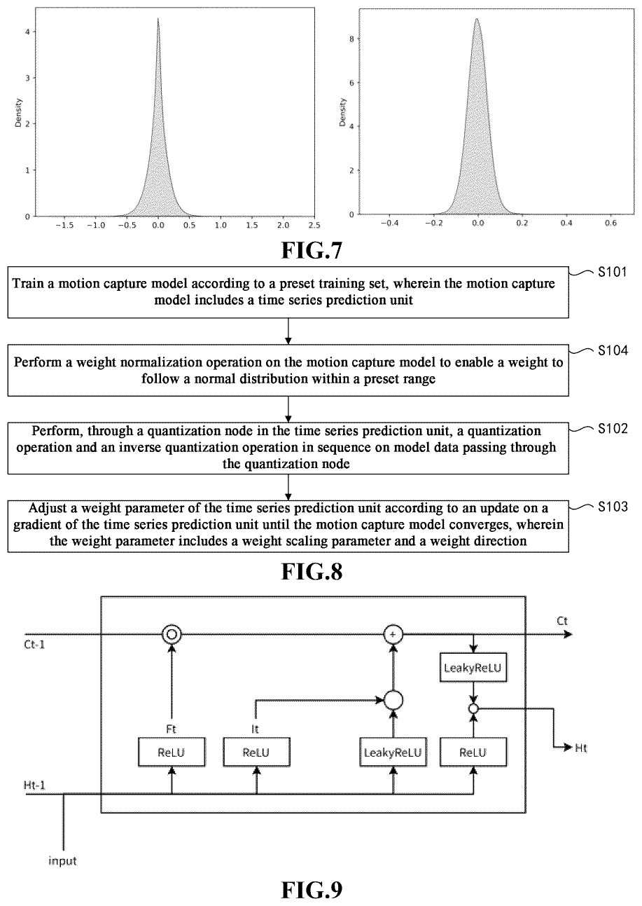

The present application may enable the model to learn statistical association information between data by acquiring sufficient datasets (i.e. training sets). Secondly, the time series prediction unit is associated with historical data information. a Forward Kinematics (FK) mechanism and an Inverse Kinematics (IK) mechanism can be used to determine a spatial position of a target object, so as to improve the detection accuracy. Furthermore, since the quantization errors are introduced for model training, an inference result of the model can eliminate and correct an accumulated drift error of the IMU. In addition, in the training process of the model, the entire update process introduces the quantization errors, so that quantization noise is resisted and eliminated in the training process all the time. A weight and an activation value are normally distributed throughout the entire training process, but they can be trained from a quantization-unfriendly normal distribution to a quantization-friendly normal distribution. The distribution of the weight is taken as an example, the left-hand side figure and the right-hand side figure in FIG. 5 show weight distributions of a first layer of time series prediction unit before and after training; the left-hand side figure and the right-hand side figure in FIG. 6 show weight distributions of a middle layer of time series prediction unit before and after training; and the left-hand side figure and the right-hand side figure in FIG. 7 show weight distributions of a last layer of time series prediction unit before and after training. It can be found that compared with an original initialized weight, the quantization-friendly Recurrent structure has a more dispersed distribution. With network training, a balance between model performance and quantitative-friendliness can be achieved.

Alternatively, the weight direction may be obtained according to the weight of the weight parameter and a modulus of the weight.

Specifically, in the LSTM, for each row of Wⱼ, the function is represented as:

$$WN ( {W}_{j} , x ) = {g}_{j} \frac{{w}_{i}}{‖ \text{?} ‖} x ,$$

$$\text{?} \text{indicates text missing or illegible when filed}$$

where gⱼ represents a trainable scaling factor, namely, the weight scaling parameter; Wⱼ represents a weight of a j^{th} row in the time series prediction unit; and

$$\frac{{W}_{j}}{‖ {W}_{j} ‖}$$

represents the weight direction.

The weight of the weight parameter is a vector. A unit vector that is the same as the direction of the weight can be obtained by a quotient of the weight and the modulus of the weight. The direction of the unit vector is the weight direction. The weight parameter may be a product of the unit vector and the weight scaling parameter. In this way, the scale and direction of the weight can be adjusted by adjusting the weight scaling parameter and the weight direction.

In some implementations, the update on the gradient of the time series prediction unit satisfies a preset normal form constraint, and the preset normal form constraint includes a weight parameter and a diagonal matrix corresponding to the weight parameter.

Specifically, to ensure that the gradient of the time series prediction unit is updated towards the quantization-friendly and convergent direction, the update on the gradient can be constrained during the update of the gradient. For example, the update on the gradient needs to satisfy the preset normal form constraint. The preset normal form constraint includes a weight parameter and a diagonal matrix corresponding to the weight parameter. The diagonal matrix is a matrix where all elements except a main diagonal are 0. Since the diagonal matrix corresponding to the weight parameter is obtained according to a weight of a diagonal of a matrix corresponding to the weight parameter, the weight parameter and the diagonal matrix corresponding to the weight parameter can be synchronously scaled, namely, their scaling ratios are the same. By introducing the weight parameter and the diagonal matrix corresponding to the weight parameter into the preset normal form constraint, the backpropagation of the parameter of the time series prediction unit may not be affected by the scaling of the matrix corresponding to the weight parameter caused by quantization.

Alternatively, the weight parameter includes one or more of a parameter of a hidden layer forget gate, a parameter of a hidden layer input gate, a parameter of a hidden layer output gate, and a parameter of a hidden layer activation gate.

Alternatively, the preset normal form constraint includes:

$$‖ \frac{\partial ξ m}{\partial {ℏ}_{t - 1}} ‖ - ( \frac{{g}_{i}}{4} {‖ {D}_{i}^{- 1} {W}_{hi} ‖}_{2} + \frac{γ 1 {g}_{f}}{4} {‖ {D}_{f}^{- 1} {W}_{hf} ‖}_{2} + {g}_{a} {‖ {D}_{a}^{- 1} {W}_{ha} ‖}_{2} ) ‖ \frac{\partial ξ m}{\partial {c}_{t + 1}} ‖ \leq ( \frac{{g}_{i}}{4} {‖ {D}_{i}^{- 1} {W}_{hi} ‖}_{2} + \frac{γ 1 {g}_{f}}{4} {‖ {D}_{f}^{- 1} {W}_{hf} ‖}_{2} + {g}_{a} {‖ {D}_{a}^{- 1} {W}_{ha} ‖}_{2} + \frac{{g}_{o}}{4} {‖ {D}_{o}^{- 1} {W}_{h o} ‖}_{2} ) ‖ \frac{\partial ξ m}{\partial {ℏ}_{t - 1}} ‖ ;$$

where ∂ represents a partial derivative; ξₘ represents a parameter of a network; D represents a diagonal matrix (e.g., D_{f} is a diagonal matrix corresponding to W_{hf}, Dᵢ is a diagonal matrix corresponding to Wₕᵢ, Dₐ is a diagonal matrix corresponding to Wₕₐ, and Dₒ is a diagonal matrix corresponding to Wₕₒ); W_{hf} and g_{f} respectively represent the parameter of the hidden layer forget gate and a corresponding gradient; Wₕᵢ and gᵢ respectively represent the parameter of the hidden layer input gate and a corresponding gradient; Wₕₒ and gₒ respectively represent the parameter of the hidden layer output gate and a corresponding gradient; and Wₕₐ and gₐ respectively represent the parameter of the hidden layer activation gate and a corresponding gradient.

It can be seen that the matrix corresponding to the weight parameter is multiplied by a transposed matrix of the diagonal matrix corresponding to the weight parameter, such as D_{f}⁻¹*W_{hf}. The weight parameter and the diagonal matrix corresponding to the weight parameter are synchronously scaled, so that the backpropagation of the parameter of the time series prediction unit may not be affected by the scaling of the matrix corresponding to the weight parameter caused by quantization.

Moreover, in a case that the update on the gradient satisfies the above preset normal form constraint, the gradient explosion problem in training can also be relieved. Moreover, there is a limitation on the update on the gradient, which can prevent the weight of the time series prediction unit from deviating from the expected quantization-friendly direction and ensure the stability of training.

With the update on the gradient, the weight parameter (e.g., W_{hf} and Wₕᵢ) will continuously adapt to the introduced quantization errors during the adjustment, thereby ensuring that the model that is trained to converge can eliminate the errors caused by the IMU and improve the detection accuracy of the model. After the mode is trained to converge by the quantization-friendly time series prediction unit, the model can eliminate the quantization errors, so that even if hardware may be quantized to transform a floating-point number to a fixed-point number during hardware deployment, the accuracy loss caused by the quantization is relatively low. Thus, the model has a low hardware requirement and can deploy hardware more widely.

In some implementations, the quantization node in the time series prediction unit is revoked in a case that the motion capture model converges.

Specifically, the quantization node is intended to introduce the quantization error in the training process. In a case that the model is trained to converge, if the quantization node still exists in the model, during detection by the model, IMU data may cause an error and the model itself may introduce a quantization error again. This may possibly cause an excessive error that the model can hardly accurately eliminate. Therefore, in a case that the motion capture model is trained to converge, the quantization node in the time series prediction unit can be revoked, so that the model only needs to eliminate the error of the IMU, which ensures the detection accuracy of the model.

FIG. 3 is a flowchart of a model training method provided by an embodiment of the present application. The method, for example, may be performed by, but not limited to, the terminal device 110 or the server 120 as shown in FIG. 1. As shown in FIG. 8, the method may include the following steps:

S104: A weight normalization operation is performed on the motion capture model to enable a weight to follow a normal distribution within a preset range.

Specifically, the error of the time series prediction unit has a significant impact on the overall performance. This error will be accumulated continuously through the Hidden State. This accumulation process is related to a weight of the time series prediction unit, and a value and distribution of an input of the time series prediction unit. Therefore, it is required that the distribution of the error is symmetric about 0 (e.g., a normal distribution), so that the quantization errors can counteract each other without generating a cumulative error. Weight Normalization can scale the weight of the model to a preset range and make the normalized weight follow the normal distribution, thereby eliminating the cumulative error to a certain extent, improving the generalization and stability of the model, and making the model easier to control.

However, using only the weight normalization can only ensure the stability of the initial process. With the training of a network, a weight and activation value of the network may gradually lose quantization friendliness. Therefore, the present application introduces the quantization errors in the training process, so that the weight parameter continuously adapts to the quantization errors in the training process, thereby ensuring that the distribution of the weight can adaptively eliminate the quantization errors throughout the entire network update process, and making the model maintain its quantization friendliness all the time.

In some implementations, an activation function of the time series prediction unit includes a Relu activation function and a LeakyRelu activation function.

Specifically, in the whole-body motion capture model, after the pose data is input, the time series prediction unit first performs position estimation, then completes joint points of the whole body, and finally performs inverse solution on a human body pose, thereby outputting a pose of the target object.

In the detection process of the model, the model is mainly used to store historical trajectory information and cause an impact on current joint position and angle detection. Therefore, the Sigmoid activation function and the Tanh activation function used in the conventional LSTM are non-linear activation functions and are quantization-unfriendly. Therefore, the functions can be changed to quantization-friendly (linear or piecewise-linear) activation functions. For example, the Sigmoid activation function is replaced with the ReLU activation function, and the Tanh activation function is replaced with the LeakyReLU activation function. In the modified time series prediction unit as shown in FIG. 9, the activation function only includes the Relu activation function and the LeakyRelu activation function. This is conducive to achieving quantization friendliness and reducing the running time of the model.

Experimental results of the LSTM using different activation functions are as shown in the following table:

| Model | | Parameter | Theoretical | Hardware | Quantization | |
|---|---|---|---|---|---|---|
| No. | Model | quantity | index | index | loss | Delay |
| 1 | LSTM | 267K | 92.933% | 82.9% | 10.03% | 20 ms |
| 2 | LSTM + | 272K | 66.66% | 50% | 16.65% | 26 ms |
| | hardsigmoid + | | | | | |
| | hardtanh | | | | | |
| 3 | LSTM + | 267K | 23.60% | 23.10% | 0.5% | 5 ms |
| | ReLU | | | | | |
| 4 | LSTM + | 280K | 85.6% | 74.10% | 10.80% | 18 ms |
| | LeakyReLU | | | | | |
| 5 | LSTM + | 273K | 89% | 88.7% | 0.3% | 11 ms |
| | ReLU + | | | | | |
| | LeakyReLU | | | | | |

It can be seen that first, in terms of a network running delay and resource utilization, a combination of several linear activation functions has achieved a balance between accuracy and speed in a whole-body motion capture task. Second, according to the scheme for training the model in terms of the quantization errors introduced by the LSTM unit, the model can be stably trained because there are no problems of gradient disappearing and gradient explosion in the training process. Finally, the time series prediction unit with the modified linear activation function can also alleviate the problem of the accuracy decrease caused by the quantization of the model.

By comparing Model 1 with Model 5, after the activation function is replaced, the accuracy can be restored to be close to the accuracy of the original whole-body motion capture model through a reasonable sectioned linear combination. The hardware index has been improved from 82.9% to 88.7%, the quantization loss has been reduced from 10% to 0.3%, and the running time has been shortened from 20 ms to 11 ms.

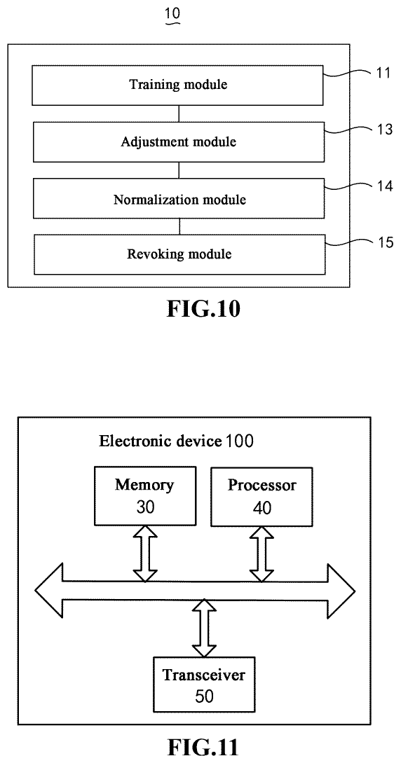

FIG. 10 is a schematic structural diagram of a model training apparatus 10 provided by an embodiment of the present application. As shown in FIG. 10, the model training apparatus 10 may include: a training module 11 and an adjustment module 13. The training module 11 is configured to: train a motion capture model according to a preset training set, wherein the motion capture model includes a time series prediction unit; the time series prediction unit includes a quantization node; the quantization node is used for performing a quantization operation and an inverse quantization operation in sequence on model data passing through the quantization node; and an adjustment module is configured to adjust a weight parameter of the time series prediction unit according to an update on a gradient of the time series prediction unit until the motion capture model converges, wherein the weight parameter includes a weight scaling parameter and a weight direction.

The quantization node is further specifically configured to: perform the quantization operation on the model data based on a preset maximum value, a preset minimum value, and a preset scaling factor; and perform the inverse quantization operation on the quantized model data based on the scaling factor.

The model training apparatus 10 may further include a normalization module 14. The normalization module 14 is configured to perform a weight normalization operation on the motion capture model to enable a weight to follow a normal distribution within a preset range.

The model training apparatus 10 may further include a revoking module 15. The revoking module 15 is configured to revoke the quantization node in the time series prediction unit in a case that the motion capture model converges.

It should be understood that the apparatus embodiment and the method embodiment can correspond to each other, and similar descriptions can be found in the method embodiment. To avoid repetitions, details will not be elaborated here. Specifically, the model training apparatus 10 shown in FIG. 10 can perform the model training method in any one of the above implementations. For brevity, it will not be elaborated here.

The above describes the model training apparatus provided by an embodiment of the present application from the perspective of functional modules in conjunction with the accompanying drawings. It should be understood that the functional modules can be implemented through hardware, software instructions, or a combination of hardware and software modules. Specifically, all the steps of the method embodiment in the embodiments of the present application can be completed through an integrated logic circuit of hardware in a processor and/or software instructions. The steps of the method disclosed by an embodiment of the present application can be directly reflected in being executed by a hardware encoding processor or by a combination of hardware and software modules in an encoding processor. Alternatively, the software modules may be stored in a storage medium that is mature in the art, such as a Random Access Memory (RAM), a flash memory, a Read-Only Memory (ROM), a programmable ROM, an electrically erasable programmable memory, or a register. The storage medium is located in a memory. The processor reads information in the memory and completes the steps of the above method embodiment in combination with the hardware of the processor.

FIG. 11 is a schematic block diagram of an electronic device 100 provided by an embodiment of the present application. The electronic device 100 may be the terminal device or the server in the above method embodiment.

As shown in FIG. 11, the electronic device 100 may include:
a memory 30 and a processor 40. The memory 30 is configured to: store a computer program and transmit the computer program to the processor 40. Namely, the processor 40 may call and run the computer program from the memory 30 to implement the model training method in any one of the implementations of the present application.

Alternatively, the processor 40 may include, but is not limited to:
a general-purpose processor, a digital signal processor (DSP), an application-specific integrated circuit (ASIC), a field-programmable gate array (FPGA) or another programmable logic device, a discrete gate or transistor logic device, a discrete hardware component, and the like.

Alternatively, the memory 30 includes, but is not limited to:
a volatile memory and/or a non-volatile memory. The non-volatile memory may be a ROM, a programmable ROM (PROM), an erasable PROM (EPROM), an electrically EPROM (EEPROM), or a flash memory. The volatile memory may be a RAM serving as an external cache. Through illustrative but not limited description, RAMs in many forms, for example, a static RAM (SRAM), a dynamic RAM (DRAM), a synchronous DRAM (SDRAM), a double data rate SDRAM (DDRSDRAM), an enhanced SDRAM (ESDRAM), a synch link DRAM (SLDRAM), and a direct rambus RAM (DRRAM), are available.

In some embodiments of the present application, the computer program may be partitioned into one or more modules, and the one or more modules are stored in the memory 30 and executed by the processor 40 to complete the method provided by the present application. The one or more modules may be a series of computer program instruction segments capable of completing specific functions. The instruction segments are used for describing an execution process of the computer program in the electronic device 100.

As shown in FIG. 11, the electronic device may further include:
a transceiver 50. The transceiver 50 may be connected to the processor 40 or the memory 30.

The processor 40 may control the transceiver 50 to communicate with another device. Specifically, the processor 40 may send information or data to the another device or receive information or data sent by the another device. The transceiver 50 may include a transmitter and a receiver. The transceiver 50 may further include antennas, and a quantity of the antennas may be one or more.

It should be understood that all the components in the electronic device 100 are connected to each other through a bus system. The bus system further includes a power supply bus, a control bus, and a state signal bus in addition to a data bus.

The present application further provides a non-volatile computer storage medium, having a computer program stored thereon. The computer program, when run by a processor, causes the processor to perform the model training method in any of the above implementations. For brevity, it will not be elaborated here.

The embodiments of the present application further provide a computer program product including computer program instructions. The computer program instructions include instructions that perform the model training method in any of the above implementations. For brevity, they will not be elaborated here.

When software is used to implement the embodiments, all or a part of the embodiments may be implemented in a form of a computer program product. The computer program product includes one or more computer program instructions. When the computer program instructions are loaded and executed on a computer, flows or functions according to the embodiments of the present application are all or partially generated. The computer may be a general-purpose computer, a special-purpose computer, a computer network, or other programmable apparatuses. The computer program instructions may be stored in a computer-readable storage medium or transmitted from one computer-readable storage medium to another computer-readable storage medium. For example, the computer program instructions may be transmitted from one website, computer, server or data center to another website, computer, server or data center in a wired manner (for example, a coaxial cable, an optical fiber, or a digital subscriber line (DSL)) or a wireless manner (for example, infrared, radio, or microwave). The computer-readable storage medium may be any usable medium that can be accessed by the computer, or a data storage device, for example, a server or a data center, integrating one or more usable media. The usable medium may be a magnetic medium (for example, a floppy disk, a hard disk, or a magnetic tape), an optical medium (for example, a digital video disc DVD)), a semiconductor medium (for example, a solid state disk (SSD)), or the like.

Those of ordinary skill in the art may recognize that the various illustrative modules and algorithm steps described in connection with the embodiments disclosed herein may be implemented as electronic hardware, or combinations of computer software and electronic hardware. Whether these functions are implemented as hardware or software depends on particular application and design constraint conditions of the technical solutions. A person skilled in the art may use different methods to implement the described functions for each particular application, but it should not be considered that the implementation goes beyond the scope of the present application.

In the several embodiments provided in the present application, it should be understood that the disclosed system, apparatus, and method are achieved in other manners. For example, the above-described apparatus embodiment is merely illustrative. For example, the division of the modules is only one type of logical functional division, and other divisions is achieved in practice. For example, multiple modules or components can be combined or integrated into another system, or some features can be omitted, or not executed. In addition, the shown or discussed mutual coupling or direct coupling or communication connection is an indirect coupling or communication connection through some interfaces, apparatuses or modules, and is in an electrical, mechanical or another form.

The modules described as separate parts may or may not be physically separate, and parts displayed as modules may or may not be physical modules, may be located in one position, or may be distributed on a plurality of network units. Some or all of the modules are selected according to actual needs to achieve the objective of the solution of this embodiment. For example, functional modules in embodiments of the present application may be integrated into one processing module, or each of the modules may exist alone physically, or two or more modules are integrated into one module.

The above descriptions are merely specific implementations of the present application, but are not intended to limit the protection scope of the present application. Any variation or replacement readily figured out by a person skilled in the art within the technical scope disclosed in the present application shall fall within the protection scope of the present application. Therefore, the protection scope of the present application shall be subject to the protection scope of the claims.

I/We claim:

1. A model training method, comprising:
training a motion capture model according to a preset training set, wherein the motion capture model comprises a time series prediction unit;
performing, through a quantization node in the time series prediction unit, a quantization operation and an inverse quantization operation in sequence on model data passing through the quantization node; and
adjusting a weight parameter of the time series prediction unit according to an update on a gradient of the time series prediction unit until the motion capture model converges, wherein the weight parameter comprises a weight scaling parameter and a weight direction.

2. The model training method of claim 1, wherein performing the quantization operation and the inverse quantization operation in sequence on the model data passing through the quantization node comprises:
performing the quantization operation on the model data based on a preset maximum value, a preset minimum value, and a preset scaling factor; and
performing the inverse quantization operation on the quantized model data based on the scaling factor.

3. The model training method of claim 1, wherein the update on the gradient of the time series prediction unit satisfies a preset normal form constraint, and the preset normal form constraint comprises a weight parameter and a diagonal matrix corresponding to the weight parameter.

4. The model training method of claim 3, wherein the weight parameter comprises one or more of a parameter of a hidden layer forget gate, a parameter of a hidden layer input gate, a parameter of a hidden layer output gate, and a parameter of a hidden layer activation gate.

5. The model training method of claim 4, wherein the preset normal form constraint comprises:
$$‖ \frac{\partial ξ m}{\partial {ℏ}_{t - 1}} ‖ - ( \frac{{g}_{i}}{4} {‖ {D}_{i}^{- 1} {W}_{hi} ‖}_{2} + \frac{γ 1 {g}_{f}}{4} {‖ {D}_{f}^{- 1} {W}_{hf} ‖}_{2} + {g}_{a} {‖ {D}_{a}^{- 1} {W}_{ha} ‖}_{2} ) ‖ \frac{\partial ξ m}{\partial {c}_{t + 1}} ‖ \leq ( \frac{{g}_{i}}{4} {‖ {D}_{i}^{- 1} {W}_{hi} ‖}_{2} + \frac{γ 1 {g}_{f}}{4} {‖ {D}_{f}^{- 1} {W}_{hf} ‖}_{2} + {g}_{a} {‖ {D}_{a}^{- 1} {W}_{ha} ‖}_{2} + \frac{{g}_{o}}{4} {‖ {D}_{o}^{- 1} {W}_{h o} ‖}_{2} ) ‖ \frac{\partial ξ m}{\partial {ℏ}_{t - 1}} ‖ ;$$
wherein ∂ represents a partial derivative; ξₘ represents a parameter of a network; D represents a diagonal matrix; W_{hf} and g_{f} respectively represent the parameter of the hidden layer forget gate and a corresponding gradient; Wₕᵢ and gᵢ respectively represent the parameter of the hidden layer input gate and a corresponding gradient; Wₕₒ and gₒ respectively represent the parameter of the hidden layer output gate and a corresponding gradient; and Wₕₐ and gₐ respectively represent the parameter of the hidden layer activation gate and a corresponding gradient.

6. The model training method of claim 1, wherein the model data comprises at least one of a weight of input data of the time series prediction unit, a weight of short-term memory data, bias data, and output data of the time series prediction unit.

7. The model training method of claim 1, further comprising:
performing a weight normalization operation on the motion capture model to enable a weight to follow a normal distribution within a preset range.

8. The model training method of claim 1, wherein an activation function of the time series prediction unit comprises a Relu activation function and a LeakyRelu activation function.

9. The model training method of claim 1, wherein the weight direction is determined according to a weight of the weight parameter and a modulus of the weight.

10. The model training method of claim 1, further comprising:
revoking the quantization node in the time series prediction unit in the case of the motion capture model converging.

11. An electronic device, comprising:
a processor and a memory, wherein the memory is configured to store a computer program, and the processor is configured to call and run the computer program stored in the memory to:
train a motion capture model according to a preset training set, wherein the motion capture model comprises a time series prediction unit;
perform, through a quantization node in the time series prediction unit, a quantization operation and an inverse quantization operation in sequence on model data passing through the quantization node; and
adjust a weight parameter of the time series prediction unit according to an update on a gradient of the time series prediction unit until the motion capture model converges, wherein the weight parameter comprises a weight scaling parameter and a weight direction.

12. The electronic device of claim 11, wherein the electronic device is caused to perform the quantization operation and the inverse quantization operation in sequence on the model data passing through the quantization node by:
performing the quantization operation on the model data based on a preset maximum value, a preset minimum value, and a preset scaling factor; and
performing the inverse quantization operation on the quantized model data based on the scaling factor.

13. The electronic device of claim 11, wherein the update on the gradient of the time series prediction unit satisfies a preset normal form constraint, and the preset normal form constraint comprises a weight parameter and a diagonal matrix corresponding to the weight parameter.

14. The electronic device of claim 13, wherein the weight parameter comprises one or more of a parameter of a hidden layer forget gate, a parameter of a hidden layer input gate, a parameter of a hidden layer output gate, and a parameter of a hidden layer activation gate.

15. The model training method of claim 14, wherein the preset normal form constraint comprises:
$$‖ \frac{\partial ξ m}{\partial {ℏ}_{t - 1}} ‖ - ( \frac{{g}_{i}}{4} {‖ {D}_{i}^{- 1} {W}_{hi} ‖}_{2} + \frac{γ 1 {g}_{f}}{4} {‖ {D}_{f}^{- 1} {W}_{hf} ‖}_{2} + {g}_{a} {‖ {D}_{a}^{- 1} {W}_{ha} ‖}_{2} ) ‖ \frac{\partial ξ m}{\partial {c}_{t + 1}} ‖ \leq ( \frac{{g}_{i}}{4} {‖ {D}_{i}^{- 1} {W}_{hi} ‖}_{2} + \frac{γ 1 {g}_{f}}{4} {‖ {D}_{f}^{- 1} {W}_{hf} ‖}_{2} + {g}_{a} {‖ {D}_{a}^{- 1} {W}_{ha} ‖}_{2} + \frac{{g}_{o}}{4} {‖ {D}_{o}^{- 1} {W}_{h o} ‖}_{2} ) ‖ \frac{\partial ξ m}{\partial {ℏ}_{t - 1}} ‖ ;$$
wherein ∂ represents a partial derivative; ξₘ represents a parameter of a network; D represents a diagonal matrix; W_{hf} and g_{f} respectively represent the parameter of the hidden layer forget gate and a corresponding gradient; Wₕᵢ and gᵢ respectively represent the parameter of the hidden layer input gate and a corresponding gradient; Wₕₒ and gₒ respectively represent the parameter of the hidden layer output gate and a corresponding gradient; and Wₕₐ and gₐ respectively represent the parameter of the hidden layer activation gate and a corresponding gradient.

16. The electronic device of claim 11, wherein the model data comprises at least one of a weight of input data of the time series prediction unit, a weight of short-term memory data, bias data, and output data of the time series prediction unit.

17. The electronic device of claim 11, the electronic device is further caused to:
perform a weight normalization operation on the motion capture model to enable a weight to follow a normal distribution within a preset range.

18. The electronic device of claim 11, wherein an activation function of the time series prediction unit comprises a Relu activation function and a LeakyRelu activation function.

19. The electronic device of claim 11, wherein the weight direction is determined according to a weight of the weight parameter and a modulus of the weight.

20. A non-volatile computer-readable storage medium comprising a computer program, wherein the computer program, when executed by a processor, causes the processor to perform:
train a motion capture model according to a preset training set, wherein the motion capture model comprises a time series prediction unit;
perform, through a quantization node in the time series prediction unit, a quantization operation and an inverse quantization operation in sequence on model data passing through the quantization node; and
adjust a weight parameter of the time series prediction unit according to an update on a gradient of the time series prediction unit until the motion capture model converges, wherein the weight parameter comprises a weight scaling parameter and a weight direction.
